(19) United States
(12) Patent Application Publication
(10) Pub. No.: US 2013/0039152 A1
(43) Pub. Date: Feb. 14, 2013

(54) HAND-VISION SENSING DEVICE AND HAND-VISION SENSING GLOVE

(71) Applicant: Ping Liu, Shenzhen (CN)

(72) Inventor: Ping Liu, Shenzhen (CN)

(73) Assignee: SHENZHEN DIANBOND TECHNOLOGY CO., LTD, Shenzhen, Guangdong (CN)

(21) Appl. No.: 13/642,558

(22) PCT Filed: Mar. 20, 2012
(86) PCT No.: PCT/CN12/72603

§ 371 Date: Oct. 22, 2012

(30) Foreign Application Priority Data
Mar. 22, 2011 (CN) 201110069367.5

(51) Int. Cl. G01S 15/08

(52) U.S. Cl. 367/99

(57) ABSTRACT

A hand-vision sensing device and a hand-vision sensing glove are provided. The hand-vision sensing device includes a prompting device, a controller, an ultrasonic sensor and a chromaticity sensor, in which the controller is connected to the ultrasonic sensor, the prompting device and the chromaticity sensor respectively, and two groups of ultrasonic sensors exist. The hand-vision sensing glove includes a glove main body and the hand-vision sensing device disposed on the glove main body. Through the hand-vision sensing glove, a position of an object is detected in a short distance, so that the blind person can be fast aware of a peripheral space formed by the object when using the hand-vision sensing glove, thereby assisting the blind person in manual operation and life.

### CROSS REFERENCE TO RELATED APPLICATIONS

This application is a national phase application of PCT/CN2012/072603, filed on Mar. 20, 2012. The contents of PCT/CN2012/072603 are all hereby incorporated by reference.

### BACKGROUND

1. Technical Field

The present application relates to the field of blind guidance, and more particularly to a hand-vision sensing device and a hand-vision sensing glove.

2. Related Art

Generally, a blind person in an activity directly touches an object through hand detection to know the existence and property of the object, but cannot know the color of the object. In outdoor activities, the blind person mostly uses a blind guide device specially for assisting walk such as a cane, an electronic ultrasonic cane device, or an electronic ultrasonic blind guide cap, which is mainly used to identify an object barrier around the blind person and assist the blind person in avoiding the barrier during walking The blind guide device is fixed in position with respect to the body, and can monitor a relatively large area, generally 3 m. However, the blind person frequently does manual activities in addition to walk in daily life and work, and the activities are of high randomness, so the above blind guide device cannot have a desirable blind guide effect. At present, there is still a lack of a device in assisting the blind person in identifying the position and color of the object, which brings inconvenience for the blind person in manual operation and life.

### SUMMARY

A technical problem to be solved by the present application is to compensate the deficiency of the prior art, and provide a hand-vision sensing device and a hand-vision sensing glove, so as to detect a position of an object in a short distance and the color of the object to be touched, so that the blind person can be fast aware of a peripheral space formed by the object and color of the object when using the hand-vision sensing glove, thereby assisting the blind person in manual operation and life.

The technical problem of the present application is solved through the following technical solutions.

The hand-vision sensing device includes an ultrasonic sensor, a chromaticity sensor, a controller and a prompting device, in which two groups of ultrasonic sensors exist, the ultrasonic sensors and the chromaticity sensor are connected to the controller together to detect a distance from a nearby object to the blind people and detect the color of the object to be touched, so as to assist the blind person in sensing characteristics of the object.

Preferably, the chromaticity sensor is a full digital three-dimensional chromaticity sensor, so as to directly output a full digital signal to the controller, which is more convenient in use.

Preferably, the prompting device is at least one of a voice announcer, a vibrator and a buzzer.

The hand-vision sensing glove includes a glove main body, in which the hand-vision sensing device according to any item of the above description is disposed on the glove main body.

Preferably, at least the palm portion of the glove main body is a plastic part or at least the palm portion of the glove main body is disposed with the plastic part, and the hand-vision sensing device is disposed on the plastic part.

Preferably, each group of the ultrasonic sensors includes an ultrasonic wave transmitting sensor and an ultrasonic wave receiving sensor used in cooperation with each other; and the two groups of the ultrasonic sensors are disposed respectively in a thumb and a forefinger directions, and can detect the existence of the object in a sensing area in the two different directions within a short distance, so as to “sense” the position of the object.

Preferably, the two groups of the ultrasonic sensors each have a certain detection angle, so at the same time when the ultrasonic sensors detect the object in the thumb and the forefinger directions, it is required to avoid incorrect judgment and interference caused by finger movements. The sensors should be installed in a position to avoid taking the finger movements as sensing detection objects, that is, avoid misjudging the finger movements.

Therefore, the ultrasonic sensor group in the forefinger direction is installed so that a sending axis direction of the ultrasonic wave forms an included angle α with the forefinger direction, in which β/2≦α≦90°−β/2, and β is the detection angle of the ultrasonic sensor; and/or the ultrasonic sensor group in the thumb direction is installed so that a sending axis direction of the ultrasonic wave forms an included angle γ with the thumb direction, in which β/2≦γ≦90°−β/2, and β is the detection angle of the ultrasonic sensor.

Preferably, the chromaticity sensor is disposed on a portion of the glove main body between the thumb and the forefinger, and used to detect color of an object to be touched or a touched object.

The beneficial effect of the present application is at least as follows: the ultrasonic sensors are divided into two groups, so the position of the object in a short distance (within about 1 m) can be detected, so that the blind person can be fast aware of the existing object; meanwhile, the chromaticity sensor is disposed to detect the color of the object to be touched, so as to assist the blind person in identifying the characteristics of the object, thereby assisting the blind person in manual operation and life.

### BRIEF DESCRIPTION OF THE DRAWINGS

FIG. 1 is a schematic three-dimensional view of a hand-vision sensing glove according to an embodiment of the present application;

FIG. 2 is a schematic exploded view of the hand-vision sensing glove of FIG. 1;

FIG. 3 is a schematic view of wearing a hand-vision sensing glove according to an embodiment of the present application; and

FIG. 4 is a view illustrating a detection system according to an embodiment of the present application.

### DETAILED DESCRIPTION

The present application is described in detail in the following with reference to the accompanying drawings and the preferred embodiments.

A hand-vision sensing device includes a prompting device, a controller and ultrasonic sensors, in which the controller is connected to the ultrasonic sensors and the prompting device respectively. The hand-vision sensing device further includes a chromaticity sensor, which is connected to the controller, and used to detect color of an object. Two groups of ultrasonic sensors exist.

A hand-vision sensing glove includes a glove main body, in which the hand-vision sensing device is disposed on the glove main body.

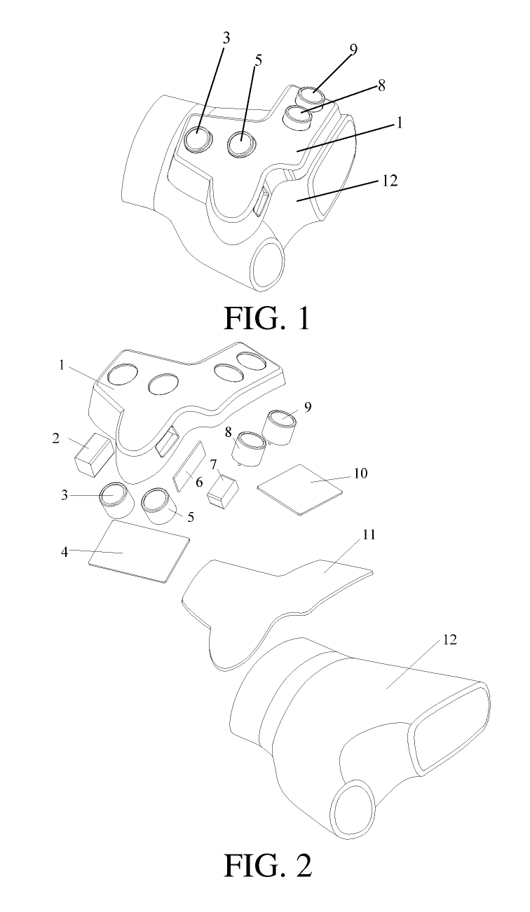

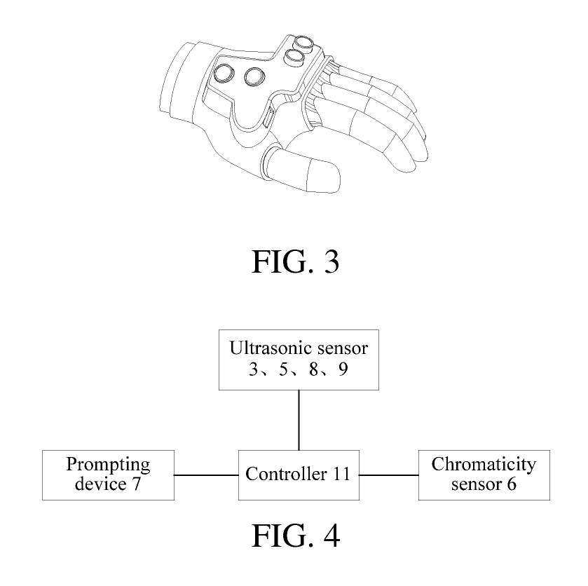

Specifically, as shown in FIG. 1, FIG. 2 and FIG. 3, the hand-vision sensing device of this embodiment is the hand-vision sensing glove. The glove main body is a leather part 12, and a plastic part 1 is disposed on a palm portion of the leather part 12 and forms an upper casing of a detection system. A microcomputer is embedded in the controller 11 and is disposed inside the plastic part 1, and in the two groups of ultrasonic sensors 3, 5, 8, and 9, 5 and 8 represent ultrasonic wave transmitting sensors, and 3 and 9 represent ultrasonic wave receiving sensors, in which the ultrasonic sensors 3 and 5 form a group, and the ultrasonic sensors 8 and 9 form another group. In the glove of this embodiment, the two groups of ultrasonic sensors are disposed with an included angle of 90°, the ultrasonic sensors 3 and 5 are installed so that a normal direction thereof forms an included angle of 45° with a thumb direction, and the ultrasonic sensors 8 and 9 are installed so that a normal direction thereof forms an included angle of 45° with a forefinger direction. Definitely, in actual applications, the two groups of ultrasonic sensors are not necessarily disposed with an included angle of 90°, as long as the ultrasonic sensor group in the forefinger direction is installed so that a sending axis direction of the ultrasonic wave forms an included angle α with the forefinger direction, in which β/2≦α≦90°β/2; and/or the ultrasonic sensor group in the thumb direction is installed so that a sending axis direction of the ultrasonic wave forms an included angle γ with the thumb direction, in which β/2≦γ≦90°−β/2, and β is a detection angle of the ultrasonic sensor. The ultrasonic sensors 3 and 5 are directly welded on a control circuit board 4, and the ultrasonic sensors 8 and 9 are directly welded on a control circuit board 10. The control circuit boards 4 and 10 are respectively connected to the controller 11 (definitely, in actual applications, the ultrasonic sensors 3, 5, 8, and 9 may be directly connected to the controller 11), the chromaticity sensor 6 is disposed on an upper position of a portion between the thumb and the forefinger and is connected to the controller 11 through a flexible cable, so as to detect color of an object to be touched. The prompting device 7 is a voice announcer, a buzzer or a vibrator, and directly buzzes, vibrates or prompts with a voice according to a detection signal of the object on the controller 11, so as to prompt the blind person of a position, a distance from the object to the blind person and color of the object. In addition, a power source for driving each portion and a power switch 2 for switch on/off are further disposed. In this embodiment, the power is supplied by a lithium cell, which is disposed inside the glove with a screw plastic cover capable of being screwed in/out.

The ultrasonic sensors 3, 5, 8, and 9, the prompting device 7, the chromaticity sensor 6, a controller 11 and a power source are connected to form a closed circuit. When the power switch 2 is switched on, the ultrasonic sensors 3, 5, 8, and 9 begin to operate. The ultrasonic wave transmitting sensors 5 and 8 transmit an ultrasonic wave to the outside, and then the ultrasonic wave receiving sensors 3 and 9 receive a returned ultrasonic wave and output a position and distance signal of the object to the controller 11 through the control circuit boards 4 and 10. The chromaticity sensor of this embodiment is a full digital three-dimensional chromaticity sensor, detects the color of the object to be touched, and directly outputs a full digital chromaticity signal to the controller 11. A computer processing system in the controller 11 analyzes and judges a position of the front object and a distance from the front object to the blind person according to a frequency and a time interval of the transmitted distance signal, obtains a chromaticity coordinate according to the chromaticity signal and identifies the color characteristic, and then prompts with a voice, vibration or buzz according to a processing result of the controller 11. The two groups of ultrasonic sensors are disposed perpendicularly, and each have a detection angle of 80°, so the ultrasonic sensors can detect a position of an object within 1 m, and therefore, the detection is more correct and reasonable. The prompt information sent from the prompting device may be divided into several levels, such as 1 m, 60 cm, 40 cm, 30 cm and other levels, and a computer programmer programs so that the prompt information of different levels varies from one other. For example, if the device prompts with buzz, the closer the device to the object is, the shorter the interval of the buzz is, and the distance from the object to the blind person is prompted by shortening the interval of sound; or if the device prompts with vibration, the distance from the object to the blind person is prompted through vibration from weak to strong; or if the device prompts with voice, the distance from the object to the blind person is directly informed through the voice; or a combination of the above prompt manners may also prompt the blind person to know the distance from the object to the blind person and the position of the object. Definitely, the listed prompt manners are not limited thereto.

Definitely, an ultrasonic sensor capable of both transmitting the ultrasonic wave and receiving the ultrasonic wave may also be used to replace the ultrasonic wave receiving sensors and the ultrasonic wave transmitting sensors.

Definitely, the hand-vision sensing device may also be a hand-hold stick, such as an electric torch. The ultrasonic sensors 3, 5, 8 and 9, and the chromaticity sensor 6 are all disposed at a front portion of a main body of the electric torch, the power source and the controller 11 embedded with the microcomputer are disposed at a rear portion of the electric torch, and the prompting device is disposed inside the main body of the electric torch; besides, the power switch 2, the same as an operating switch of the electric torch, may be disposed on an outer surface of the casing of the main body.

The above listed manners are not limited thereto, as long as each element for detecting the position, the distance from the object to the blind person, and the color is disposed on a portable carrier according to the requirements, the effect of the present invention can be achieved.

The present application is described in further detail in the above with reference to the preferred embodiments, but the specific implementation of the present application is not limited to the above description. It should be noted by persons of ordinary skill in the art that equivalent replacements or obvious variations with the same property and purpose may be made without departing from the concept of the present application, which should be construed as falling within the protection scope of the present application.

1-9. (canceled)

10. A hand-vision sensing device, comprising an ultrasonic sensor, a controller and a prompting device, wherein the ultrasonic sensor and the prompting device are connected to the controller respectively, wherein two groups of ultrasonic sensors exist and are used to detect a distance from a nearby object to a blind person; the hand-vision sensing device further comprises a chromaticity sensor, connected to the controller, and used to detect color of a touched object, thereby assisting a blind person in sensing characteristics of the object.

11. The hand-vision sensing device according to claim 10, wherein the chromaticity sensor is a full digital three-dimensional chromaticity sensor.

12. The hand-vision sensing device according to claim 10, wherein the prompting device is at least one of a voice announcer, a vibrator and a buzzer.

13. The hand-vision sensing device according to claim 11, wherein the prompting device is at least one of a voice announcer, a vibrator and a buzzer.

14. A hand-vision sensing glove, comprising a glove main body, wherein the hand-vision sensing device according to claim 10 is disposed on the glove main body.

15. The hand-vision sensing glove according to claim 14, wherein at least a palm portion of the glove main body is a plastic part or at least the palm portion of the glove main body is disposed with the plastic part, and the hand-vision sensing device is disposed on the plastic part.

16. The hand-vision sensing glove according to claim 14, wherein each group of ultrasonic sensors comprises an ultrasonic wave transmitting sensor and an ultrasonic wave receiving sensor used in cooperation with each other, and the two groups of the ultrasonic sensors are disposed respectively in a thumb and a forefinger directions, and are capable of detecting existence of an object in a sensing area in the two different directions within a short distance, so as to “sense” the position of the object.

17. The hand-vision sensing glove according to claim 16, wherein the ultrasonic sensor group in the forefinger direction is installed so that a sending axis direction of the ultrasonic wave forms an included angle α with the forefinger direction, wherein β/2≦α≦90°−β/2, and β is a detection angle of the ultrasonic sensor.

18. The hand-vision sensing glove according to claim 16, wherein the ultrasonic sensor group in the thumb direction is installed so that a sending axis direction of the ultrasonic wave forms an included angle γ with the thumb direction, wherein β/2≦γ≦90°−β/2, and β is a detection angle of the ultrasonic sensor.

19. The hand-vision sensing glove according to claim 17, wherein the ultrasonic sensor group in the thumb direction is installed so that a sending axis direction of the ultrasonic wave forms an included angle γ with the thumb direction, wherein β/2≦γ≦90°−β/2, and β is a detection angle of the ultrasonic sensor.

20. The hand-vision sensing glove according to claim 14, wherein the chromaticity sensor is disposed on a portion between the thumb and the forefinger, and used to detect color of an object to be touched or a touched object.

21. A hand-vision sensing glove, comprising a glove main body, wherein the hand-vision sensing device according to claim 12 is disposed on the glove main body.

22. The hand-vision sensing glove according to claim 21, wherein at least a palm portion of the glove main body is a plastic part or at least the palm portion of the glove main body is disposed with the plastic part, and the hand-vision sensing device is disposed on the plastic part.

23. The hand-vision sensing glove according to claim 21, wherein each group of ultrasonic sensors comprises an ultrasonic wave transmitting sensor and an ultrasonic wave receiving sensor used in cooperation with each other, and the two groups of the ultrasonic sensors are disposed respectively in a thumb and a forefinger directions, and are capable of detecting existence of an object in a sensing area in the two different directions within a short distance, so as to “sense” the position of the object.

24. The hand-vision sensing glove according to claim 23, wherein the ultrasonic sensor group in the forefinger direction is installed so that a sending axis direction of the ultrasonic wave forms an included angle α with the forefinger direction, wherein β/2≦α≦90°−β/2, and β is a detection angle of the ultrasonic sensor.

25. The hand-vision sensing glove according to claim 23, wherein the ultrasonic sensor group in the thumb direction is installed so that a sending axis direction of the ultrasonic wave forms an included angle γ with the thumb direction, wherein β/2≦γ≦90°−β/2, and β is a detection angle of the ultrasonic sensor.

26. The hand-vision sensing glove according to claim 24, wherein the ultrasonic sensor group in the thumb direction is installed so that a sending axis direction of the ultrasonic wave forms an included angle γ with the thumb direction, wherein β/2≦γ23 90°−β/2, and β is a detection angle of the ultrasonic sensor.

27. The hand-vision sensing glove according to claim 21, wherein the chromaticity sensor is disposed on a portion between the thumb and the forefinger, and used to detect color of an object to be touched or a touched object.
